(19) United States
(12) Patent Application Publication
(10) Pub. No.: US 2007/0226468 A1
(43) Pub. Date: Sep. 27, 2007

(54) Arrangements for controlling instruction and data flow in a multi-processor environment

(75) Inventors: Karl-Heinz Grabner, Probstdorf (AT); Andreas Bolzer, Vienna (AT)

Correspondence Address: Alan Carlson, 6202 Lynn Lane, Lago Vista, TX, 78645, US

(73) Assignee: ON Demand Microelectronics

(21) Appl. No.: 11/804,451

(22) Filed: May 18, 2007

(30) Foreign Application Priority Data
Dec. 3, 2004 (AT) A 2039/2004 G06F

(51) Int. Cl. G06F 15/00

(52) U.S. Cl. 712/220

(57) ABSTRACT

In one embodiment a method for controlling instruction flow in a multiprocessor environment is disclosed. The method can include retrieving at least one slice instruction that is executable by more than one processing unit in a plurality of processing units. The method can also retrieve a global instruction that indicates a processing unit from a plurality of processing units that will receive the at least one slice instruction and the method can load the at least one slice instruction to the more than one processing unit in response to the global instruction. Such instruction control can allow the system to operate in a single input multiple data (SIMD) mode, a multiple instruction multiple data (MIMD) mode or a hybrid thereof.

### FIELD OF THE INVENTION

The invention relates to parallel processing and further to allocating controlling instruction delivery in such a system.

### BACKGROUND OF THE INVENTION

There are two popular parallel processor architectures, a single instruction stream, multiple data stream (SIMD) architecture and a multiple instruction stream multiple data streams (MIMD) architecture. In a SIMD system, the same instruction is provided to all active processing units. Each processing unit can have its own set of registers along with some means for the processing unit to receive unique data. In a SIMD system each individual processing unit can have a relatively simple architecture because common functionalities can be implemented separate from the processing units. Since the units receive the same instruction common functionalities can include processor control logic, logic to fetch and logic to decode. Such arrangement can be implemented in a relatively small chip area.

In MIMD architectures, every processing unit typically has a register for storing instructions and can operate independently from the other processing units. A MIMD processor may also be termed a “multi-processor”, because each processing unit can be a full independently operable processor. Thus, a MIMD processor and processor architecture is much more flexible than a SIMD processor. However, MIMD processors with the same number of parallel processing units can require significantly more chip area as each processing unit can require extensive support such as logic for controlling the program flow and memory retrieval control logic to name a few.

SIMD architectures can be used efficiently when the same algorithm is applied to different data. Such algorithms do not depend on the data they process and can be, e.g., image or video-processing algorithms where exactly one algorithm is applied on a multitude of pixel data. However, SIMD architectures cannot be efficiently applied on algorithms that have strong data-dependencies, conditional jumps etc. On contrary, processing units of MIMD architectures can each efficiently execute different algorithms. One problem that programmers face in MIMD programming is to synchronize the different algorithms to ensure proper timing of events. As discussed above both MIMD and SIMD architectures have shortcomings in what they can process and how they must be configured.

### SUMMARY OF THE INVENTION

In one embodiment a method for controlling instruction flow in a multiprocessor environment is disclosed. The method can include retrieving at least one slice instruction that is executable by more than one processing unit in a plurality of processing units. The method can also retrieve a global instruction that indicates a processing unit from a plurality of processing units that will receive the at least one slice instruction and the method can load the at least one slice instruction to the more than one processing unit in response to the global instruction. Such instruction control can allow the system to operate in a single input multiple data (SIMD) mode, a multiple instruction multiple data (MIMD) mode or a hybrid thereof.

In another embodiment a system is disclosed that has a plurality of processing units a first storage register to store a slice instruction where the slice instruction processable by more than one processing unit of a plurality of processing units. The system can also include at least a second portion of a storage register to store a processor slice allocation instruction, where the processor slice allocation instruction controls which of the plurality of processing units gets the slice instruction. The system can also include a switching module coupled to the plurality of processing units and the register to feed the slice instruction to at least one of the plurality of processing units.

### BRIEF DESCRIPTION OF THE DRAWINGS

In the following the disclosure is explained in further detail with the use of preferred embodiments, which shall not limit the scope of the invention.

FIG. 1 is a block diagram of a data processing system according to the disclosure where only those modules are shown which are of importance to understand the disclosure;

FIG. 2 is a schematic diagram of instruction processing in SIMD mode, where only one slice instruction word is used in a processor instruction for all N processing units;

FIG. 3 is a schematic diagram similar to FIG. 2 of instruction processing whereas a processor instruction only contains two different slice instruction words for all N processing units;

FIG. 4 is a schematic diagram of instruction processing in MIMD mode, where for each of the N processing units a separate slice instruction word is used;

FIG. 5 is a state diagram of a control unit that can be used for the control unit 3 in FIG. 1; and

FIG. 6 shows a flow diagram of a method of fetching and distributing of instructions according to the disclosure.

### DETAILED DESCRIPTION OF THE PREFERRED EMBODIMENTS

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims. The descriptions below are designed to make such embodiments obvious to a person of ordinary skill in the art.

While specific embodiments will be described below with reference to particular configurations of hardware and/or software, those of skill in the art will realize that embodiments of the present disclosure may advantageously be implemented with other equivalent hardware and/or software systems. Aspects of the disclosure described herein may be stored or distributed on computer-readable media, including magnetic and optically readable and removable computer disks, as well as distributed electronically over the Internet or over other networks, including wireless networks. Data structures and transmission of data (including wireless transmission) particular to aspects of the disclosure are also encompassed within the scope of the disclosure.

The present disclosure presents arrangements to efficiently compress, load, and expand instructions for processing unit under the direction of a “global” instruction. Accordingly a retrieved instruction can contain a global instruction (possibly a single word) and one or more slice instructions. The global instruction can control allocation of slice instructions (instructions allocated for more than one processor slice or processing unit or to specific processors) and such a global instruction can be referred to as a processor slice allocation instruction. The global instruction can provide control information allocating slice instruction to one or more processing units or processor slices. The slice instructions can be executed by the processing units or processing slice to which they are provided.

The disclosed arrangements allow multiple processing units to efficiently store and handle processor instructions for a processor which can be operated in either a SIMD mode or a MIMD mode. In one embodiment, methods, apparatus and arrangements for fetching of instructions in a multi-unit processor that can execute very long instruction words (VLIW)s are disclosed.

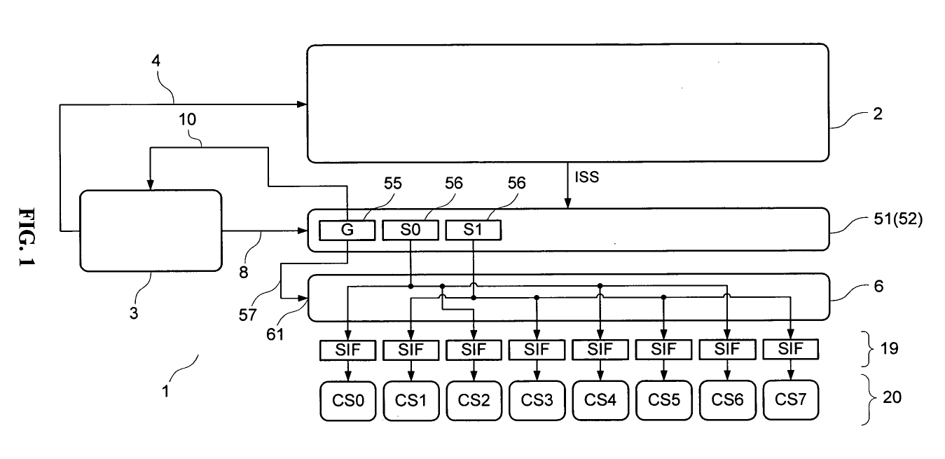

Referring to FIG. 1 a block diagram of a data processing system 1 is disclosed. The block diagram provides a simplifier processor architecture which is a small subset of modules which would typically be required to provide a functioning unit. For example modules that retrieve data and modules that forward or output data could be required but have been left out for simplification of description.

The system 1 can include a program memory 2 which can store instruction subsystem (ISS) words, a control unit 3, which can control the fetching of instructions from the program memory 2 to instruction buffers 51 or 52, and a switching logic 6 which can be controlled by the global instruction word (GIW) in the GIW register 55. The system 1 can have two instruction buffers 51 and 52 where at least one of the instruction buffers can be the active instruction buffer and the other instruction buffer can be inactive.

Instruction buffers 51 and 52 are drawn as a single buffer but can be switched in and out of communication with the switching logic. The active instruction buffer (51 or 52) can contain the instructions that will be processed in a subsequent clock cycle. In one embodiment any number of instruction buffers of arbitrary lengths can be utilized. Registers 55 and registers 56 can store processor instruction or sliced instructions. The instruction buffers 51 and 52 can also store processor instructions which have been processed or which will be processed, however, FIG. 1 only shows the active processor instruction consisting of the boxes 55 and 56 for simplicity and clearness.

The system 1 can also comprise an arbitrary number of parallel processing units 20—so-called slices. The system 1 of FIG. 1 has 8 processing units 20. However, any number of processing units could be utilized without parting from the scope of the present disclosure. Each processing unit 20 can have a slice instruction field 19 and every clock cycle can retrieve a sliced instruction from a slice instruction field 19 associated to the processing unit based on the global instruction. Each processing unit can retrieve a different slice instruction, can process the retrieved instruction, and can operate independent from the other processing units.

At each fetch cycle the ISS words can be fetched from the program memory 2 and loaded into instruction buffers 51 or 52. Each ISS word can contain a global instruction word and the slice instruction words. The global instruction word and the slice instruction words together can instruct the processor unit (which can comprise of N parallel processing units) of how to separate and deliver the slices to processing units and generally how to operate in at least one cycle.

Global instruction words can include information to control the program flow, to control the processor or other to control the handling of information generally. In addition to this information, the global instruction words 55 can contain information of how the slice instructions that are contained in processor instructions shall be distributed to the processing units 20 via switching logic 6.

At least a part of the global instruction word 55 can be forwarded to the switching logic 6 at a port 6.1 via line 57. The switching logic 6 can utilize the control information provided by the global instruction work 57 to determine how to distribute the slice instruction words 56 to the processing units 20. A detailed description of the structure and information contained in the global instruction word is discussed below.

The switching logic 6 of FIG. 1 illustrates a single example of possible connection paths between the registers 51 and 52 and the processing units 20. Thus, switching logic 6 can have many switches that interconnect the register with the processing units in many different switched configurations under the control of the global instruction. In the illustrated connection of the switching logic, the switching logic 6 forwards the slice instruction words 56 alternating to the processing units 20.

The slice instruction word 56 labeled S0 can be forwarded to the CS0, CS2, CS4, and CS6 processing units 20. In addition the slice instruction word 56 labeled S1 can be forwarded to the CS1, CS3, CS5, and CS7 processing units 20. It is to note, that the switching paths/configuration provided by switching module 6 is merely an example and the actual switches are left out for simplicity of description. Switching logic 6 can use the signal 57 to create multiple parallel paths for delivering a single slice instruction words to multiple processing units.

The control unit 3 can have a slot pointer 8 that selects the global instruction word in the active instruction buffer 55. The global instruction word can precede the slice instruction words 56 in a processor instruction. The global instruction word or parts of the global instruction word can be forwarded using a signal 10 to the control module 3. The control module 3 can use the signal 10 to compute slice pointers and to determine the subsequent global instruction word or the instruction that will follow the current processor instruction. The control unit 3 can also use a program counter 4 to fetch ISS words from the program memory 2 to the instruction buffers.

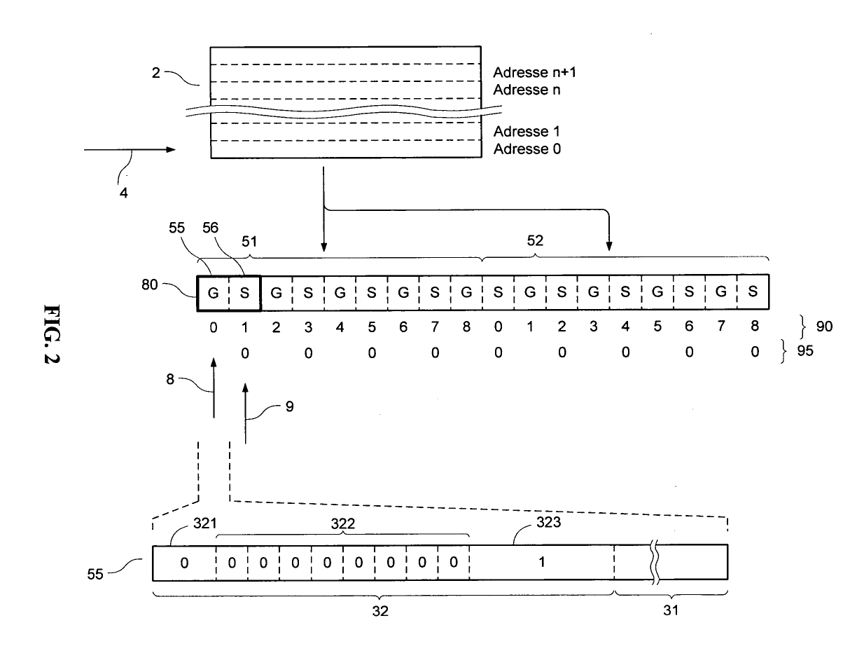

Referring to FIG. 2 a diagram which shows a possible structure of an ISS word is disclosed. In the upper part of FIG. 2, the program memory 2 is shown where each instruction has an address and the instruction can contain an ISS word. A program counter 4 can denote the address of the ISS word in the program memory which will be retrieved or fetched in the next clock cycle. A fetching module (not shown) can fetch data or an instruction from the program memory 2 and can load it into instruction buffers 51 or 52. Thus, each instruction buffer 51 or 52 can store an ISS word. An ISS word can contain one or more processor instructions. A processor instruction can include a global instruction word 55 and a series of, or at least one slice instructions 56.

The initial word or bits of a processor instruction can contain the global instruction word. The global instruction words stored in the buffers 51 and 52 are labeled with a “G” for global whereas the slice instruction words are labeled with an “S.” The ISS words stored in the buffers 51 or 52 can each include nine instruction words whereas the number of instruction words per instruction buffer can be determined by N+1. In one embodiment, an instruction word can be either a global instruction word or a slice instruction word and the global instruction can be the same size as a slice instruction.

Numbers 90 can denote the position of instruction words within the ISS words and the indices 95 can denote the position of the slice instructions within the list of slice instructions that can be included in a processor instruction. In the instruction buffers, processor instructions can be stored sequentially. In the example, the ISS word stored in buffer 51 has 4 complete processor instructions, one at positions 0 and 1, one at positions 2 and 3, one at positions 4 and 5, and one at positions 6 and 7. The last instruction word of the buffer 51 at position 8 stores a global instruction word whereas the slice instruction word of the same processor instruction is stored in position 0 of the buffer 52.

Slot pointer 8 can denote the position of the global instruction word 55 of the current processor instruction 80. A slice pointer 9 can point to the current slice instruction word 56 of the current processor instruction 80. In one embodiment, only one slice instruction word 56 can be provided in the processor instruction 80.

The lower part of FIG. 2 shows a possible structure of a global instruction word 55 in accordance with the disclosure. The global instruction word 55 can include an extension field 32 and a global instruction field 31. The global instruction field 31 can contain usual global information to control the program flow or other tasks. The extension field 32 can comprise of a switch field 321, a distribution field 322, and a control field 323. In one embodiment, of the disclosure the extension field 31 and in another embodiment of the disclosure the global instruction word 55 can be used for the control signal on line 57 as described in FIG. 1.

The switch field 321 can be either “0” or “1”. The value “0” of the switch field 321 can indicate regular operation and can cause the control unit 3 to process one processor instruction after the other whereas the value “1” can cause the control unit 3 to switch to the other instruction buffer. This can be necessary, when the next processor instruction starts at position 0 of the next ISS word. This can be the case, when this next processor instruction is also a jump target as jump targets may need to be aligned and may have to start at position 0 of an ISS word.

The control field 323 of the extension field 32 of a global instruction word 55 can indicate to the control unit 3 how many slice instruction words follow the global instruction word. In the example of FIG. 2, the extension field 323 is “1” to indicate that the global instruction 55 in the processor instruction 80 is followed by 1 slice instruction 56.

The distribution field 322 of the extension field 32 of a global instruction word 55 can tell the control unit 3 which of the slice instructions 56 that follow a global instruction 55 can be forwarded to the corresponding processing unit (the slice). Therefore, the distribution field 322 can store N indices where N can be the number of processing units 20 that can be used in the processor 1. However, it is to note, that in some embodiments of the disclosure less than N indices can be stored in the distribution field to, e.g., statistically save space in the program memory for some architectures.

However, each of the N indices can be assigned to a single processing unit. In the example of FIG. 2, all indices of the distribution field 322 are “0” which means that the slice instruction with index 0 (the first slice instruction at position 0 in the list of slice instructions of the current processor instruction 80) can be forwarded to all processing units. Therefore, the global instruction 55 of the processor instruction 80 can send a control signal to allow the processor 1 to operate in a SIMD mode for the subject processor instruction and the global instruction can also provide the slice instruction to be executed by all processor slices.

A slice pointer 9 can be used by the control unit 3 to locate the slice instruction in the current processor instruction 80. However, the example shown in FIG. 2 shows a sequence of SIMD processor instructions in the instruction buffers 51 and 52 to demonstrate the efficiency of the present method and system for SIMD instructions, whereas each SIMD processor instruction can be coded as described. The routing of the slice instruction to the processing units can be performed by the switching logic 6 according to the information in the extension field 32 in the global instruction word 55.

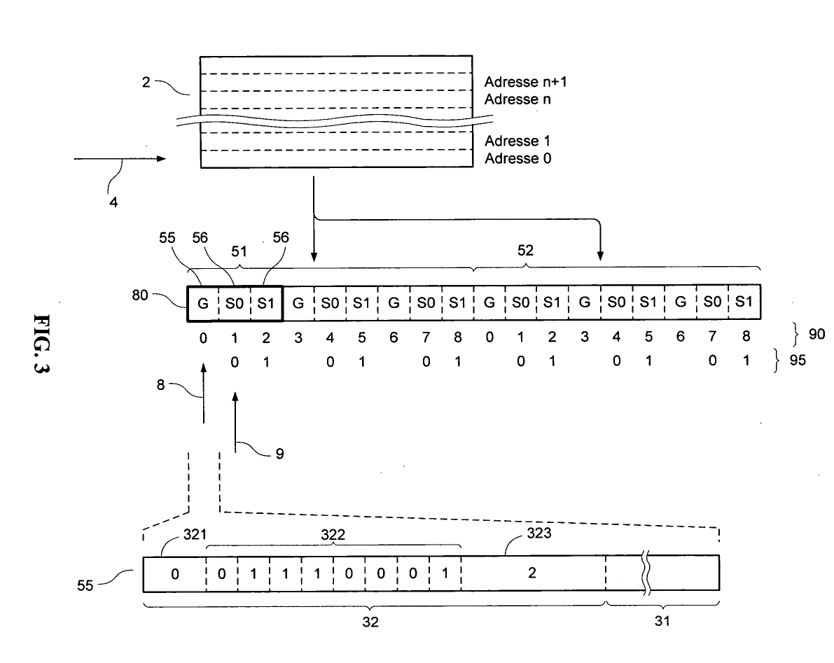

Referring to FIG. 3 a diagram is provided that is similar to that of FIG. 2 and shows the structure of another ISS word. In the upper part of FIG. 3 program memory 2 is shown which can contain the ISS words. ISS words can be loaded to instruction buffers 51 and 52. A slot pointer 8 can denote the position of the global instruction word 55 of the current processor instruction 80. A slice pointer 9 can point to the current slice instruction words 56 of the current processor instruction 80. In the example of FIG. 3 two slice instructions 56 are contained in the processor instruction 80.

The lower part of FIG. 3 shows the structure of a global instruction word 55. In the example, the extension field 323 contains “2” which can indicate that the global instruction 55 in the processor instruction 80 can be followed by 2 slice instructions 56. The distribution field 322 of the extension field 32 of a global instruction word 55 can store the combination “01110001.” Such coding can indicate that that the slice instruction with index 0 (the first slice instruction at position 0 in the list of slice instructions in the current processor instruction 80 is also to be sent to and utilized by the first, fifth, sixth, and seventh processing unit and the slice instruction with index 1 (the second slice instruction in the list of slice instructions in the current processor instruction 80) can be sent to and used by the second, third, fourth, and eighth processing unit.

Therefore, the global instruction 55 of the processor instruction 80 in FIG. 3 can provide a signal to set the processor 1 into a combined SIMD and MIMD mode for a processor instruction whereas all eight processing units can execute instructions out of two slice instructions stored in the registers 51 and 52. A slice pointer 9 can be used by the control unit 3 to locate the slice instruction in the current processor instruction 80. The routing of the slice instructions to the processing units can be performed by the switching logic 6 according to the information of the extension field 32 in the global instruction word 55.

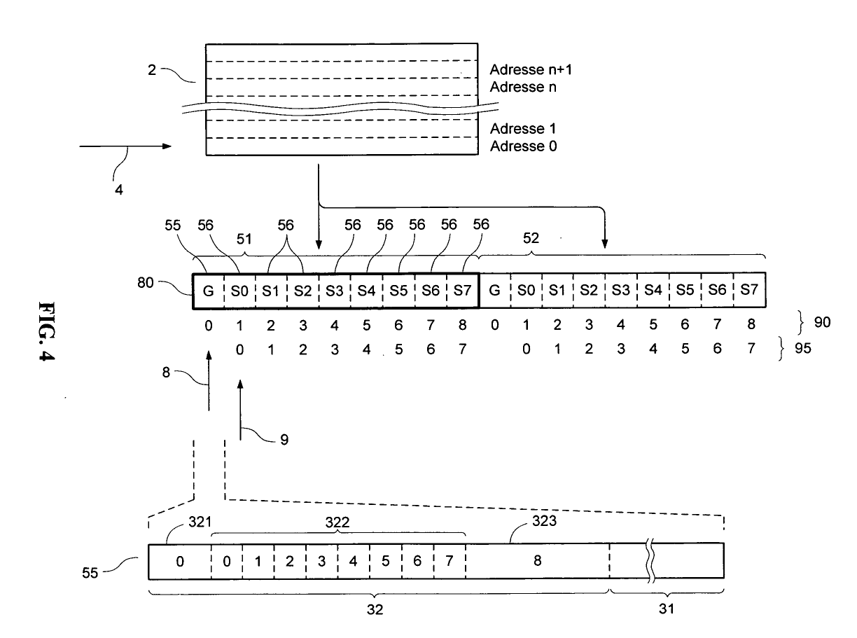

Referring to FIG. 4 a diagram similar to that of FIG. 2 and FIG. 3 is provided which shows the structure of another ISS word. In the upper part of FIG. 4 a program memory 2 module is provided which can contain the ISS words. ISS words can be loaded to instruction buffers 51 and 52. A slot pointer 8 can denote the position of the global instruction word 55 in the current processor instruction 80. A slice pointer 9 can point to the current slice instruction words 56 of the current processor instruction 80. In the example of FIG. 4 eight slice instructions 56 are contained in the processor instruction 80.

The lower part of FIG. 4 shows the structure of the global instruction word 55 of the example of FIG. 4. In the example, the extension field 323 has the number eight “8” which can indicate that the global instruction 55 in the processor instruction 80 can be followed by, or can have eight individual slice instructions 56. The distribution field 322 of the extension field 32 of a global instruction word 55 can store the combination “01234567” which can indicate that each of the eight slice instructions contained in the current processor instruction 80 will be sent to an individual processing unit. Therefore, the global instruction 55 of the processor instruction 80 can send a signal to processor 1 indication that the processor is to operated in a pure MIMD mode for that processor instruction whereas all 8 processing units execute different instructions. However, it is to note, that even all slice instructions can be the same instruction although the slice instructions for the processing units are provided separately. A slice pointer 9 can be used by the control unit 3 to locate the slice instruction in the current processor instruction 80. The routing of the slice instructions to the processing units can be performed by the switching logic 6 according to the information of the extension field 32 in the global instruction word 55.

The example shown in FIG. 3 shows two MIMD processor instructions in the instruction buffers 51 and 52 to demonstrate the capability and flexibility of the disclosed arrangements. It can be appreciated that SIMD processor instructions can immediately follow MIMD processor instructions or combined SIMD-MIMD processor instructions can be processed or vice versa. The processor 1 can, hence, be operated in a SIMD mode in one clock cycle, or in MIMD mode or combined SIMD-MIMD mode in a next clock cycle.

As demonstrated above, the disclosed arrangements are very flexible and allow for different processing architectures with the same hardware. Moreover, the arrangements are scalable as an arbitrary number of N processing units can be applied. In addition to this, the disclosed arrangements allow a significant amount of instructions to be compressed into a processor instruction in ISS words and the instructions can be expanded or decompress just prior to loading of processing units.

The number of bits that are consumed for the switch field 321 can be one bit, for the distribution field 322 N*log 2(N) bits, and for the control field 323 log 2(N) bits which results in a consumption of (N+1)*log 2(N)+1 bits. Therefore, for SIMD, MIMD and the combined mode SIMD/MIMD hybrid operation, the extension field 32 of the global instruction word 55 can consume the same length. In SIMD mode (N−1) slice instruction words can be saved when compared to operation in the MIMD mode.

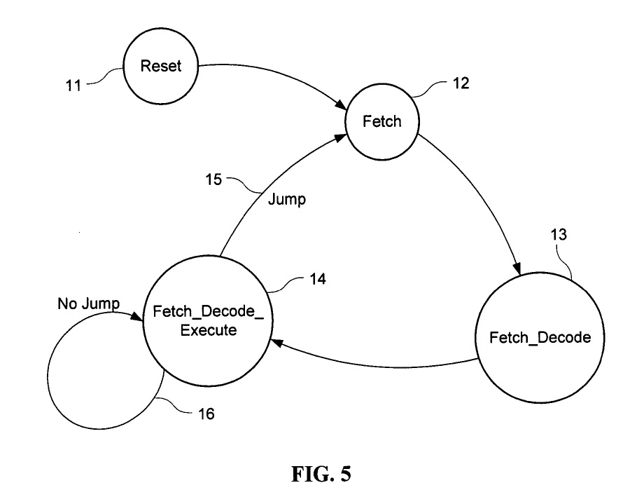

FIG. 5 is an example of a state diagram of a control unit that can be used for the control unit 3. In a reset state, the control unit can initialize a program counter 4, the slot pointer 8, slice pointers 9, and/or other system variables. After completion of the initialization the control unit 3 can go to state 12 and can fetch at least one ISS word from the program memory 2 to at least one of the instruction buffers 51 and 52. After fetching the module can go to state 13.

In state 13 the first processor instruction in the ISS word is decoded, the global instruction 55 of the processor instruction is interpreted and the slice instructions 56 can be forwarded through the slice instruction fields 19 to the processing units 20. In parallel, another ISS words can be fetched from the program memory 2 to at least one free instruction buffer.

In state 14 the subsequent processor instructions are decoded in a loop 16 as long as no jump has to be performed. Hence, in state 14 a subsequent processor instruction can be decoded while in parallel the slice instructions of a previously decoded processor instruction can be executed in the processing units 20 and next ISS words can be fetched when at least one instruction buffer is free.

In case of a jump, the control unit 3 can go to state 12 and can start to fetch a first ISS word located at the jump address. However, it is to note, that the module 3 can be implemented with other states or as a different logic. However, the state diagram of FIG. 5 is included for clearness and to understand aspects of the disclosure.

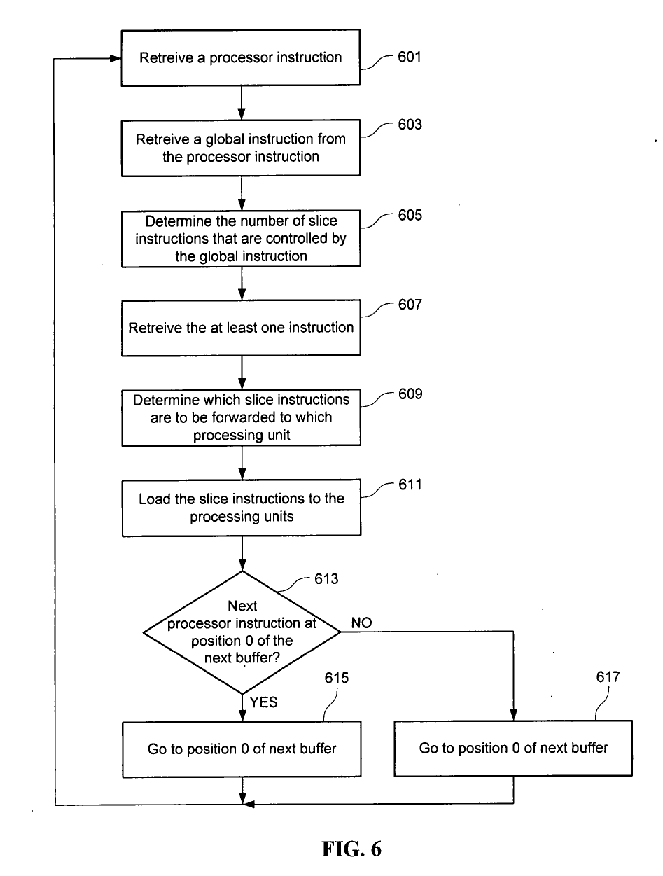

FIG. 6 shows a flow diagram of a method of fetching and distributing of instructions according to the disclosure. The method of FIG. 6 can start in block 601. As illustrated by block 601, a processor instruction can be retrieved from an instruction buffer. The control unit 3 can use a slot pointer to store the position of a processor instruction within an instruction buffer. As illustrated by block 603 the control module 3 can retrieve a global instruction from the processor instruction. The control unit can use the global instruction word to determine the number of slice instructions that can be controlled by the global instruction as illustrated by block 605.

This number can determine the number of slice instructions that can belong to the processor instruction and can be provided in a control field of the control instruction. As illustrated by block 607, the at least one slice instructions that belong to the processor instruction can be retrieved. As illustrated by block 609, the control unit 3 can determine which slice instructions are to be forwarded to which processing units. At block 611, the slice instructions can be loaded to the processing units. At decision block 613, it can be determined if the next processor instruction starts at position 0 of the next instruction buffer or if the next processor instruction is located right after the current processor instruction.

This can be determined from a switch field which can be included in the control word. If the next processor instruction starts at position 0 of the next buffer, the slot pointer can be set to that position which is illustrated by block 615. If the next processor instruction is located right after the current processor instruction, the slot pointer can be set to that position which is illustrated by block 617.

Each process disclosed herein can be implemented with a software program. The software programs described herein may be operated on any type of computer, such as personal computer, server, etc. Any programs may be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet, intranet or other networks. Such signal-bearing media, when carrying computer-readable instructions that direct the functions of the present disclosure, represent embodiments of the present disclosure.

The disclosed embodiments can take the form of an entirely hardware embodiment, an entirely software embodiment or an embodiment containing both hardware and software elements. In one embodiment, the arrangements can be implemented in software, which includes but is not limited to firmware, resident software, microcode, etc. Furthermore, the disclosure can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The control module can retrieve instructions from an electronic storage medium. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. A data processing system suitable for storing and/or executing program code can include at least one processor, logic, or a state machine coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

It will be apparent to those skilled in the art having the benefit of this disclosure that the present disclosure contemplates methods, systems, and media that can automatically tune a transmission line. It is understood that the form of the arrangements shown and described in the detailed description and the drawings are to be taken merely as examples. It is intended that the following claims be interpreted broadly to embrace all the variations of the example embodiments disclosed.

What is claimed is:

1. A method comprising:
retrieving at least one slice instruction, the slice instruction executable by more than one processing unit from a plurality of processing units;
retrieving a global instruction, the global instruction indicating which of the plurality of processing units will receive the at least one slice instruction; and
loading the at least one slice instruction to the more than one processing unit in response to the global instruction.

2. The method of claim 1, further comprising processing a single input multiple data (SIMD) instruction one clock cycle after processing a multiple instruction multiple data (MIMD) processor instruction.

3. The method of claim 1, further comprising processing a combined SIMD-MIMD processor instruction in a single clock cycle.

4. The method of claim 1, wherein retrieving comprises retrieving a plurality of slice instructions wherein the plurality of slice instruction are less than or equal to a quantity of processing units.

5. The method of claim 1, wherein the global instruction allows the plurality of processing units to operate in one of a single instruction multiple data (SIMD) mode, a multiple instruction multiple data (MIMD) mode or a hybrid SIMD/MIMD mode.

6. The method of claim 1, where the global instruction indicates how many slice instruction words are controlled by the global instruction.

7. The method of claim 1, wherein global instruction further indicates a specific slice instruction to be forwarded to specific processing units.

8. The method of claim 1, wherein the global instruction comprises a distribution field that stores a number of indices N where N is a number of processing units that can be utilized by slice instructions

9. The method of claim 1, wherein the global instruction has indices indicating which processing unit will receive a specific slice instruction.

10. The method of claim 1, wherein the global instruction has a slice pointer to locate the slice instruction in a register containing a current processor instruction and a switch indicator to indicate a buffer to be utilized.

11. A system comprising:
a plurality of processing units;
at least a first portion of a storage register coupled to the plurality of processing units, the at least a first portion of the storage register to store a slice instruction, the slice instruction processable by more than one processing unit of a plurality of processing units; and
at least a second portion of a storage register coupled to the at least a first portion of a storage register, the at least a second portion of the storage register to store a processor slice allocation instruction, where the processor slice allocation instruction controls which of the plurality of processing units gets the slice instruction.

12. The system of claim 11, further comprising a switching module coupled to the plurality of processing units and the register to feed the slice instruction to at least one of the plurality of processing units.

13. The system of claim 11, further comprising a second storage register to alternate feeding the plurality of processing units with the at least first and at least second portion of the storage register.

14. The system of claim 11, further comprising a controller coupled to the plurality of processing units, the controller to control the switch module in response to the slice allocation instruction.

15. A computer program product comprising a computer useable medium having a computer readable program, wherein the computer readable program when executed on a computer causes the computer to:
retrieve at least one slice instruction, the slice instruction executable by more than one processing unit from a plurality of processing units;
retrieve a global instruction, the global instruction indicating which of the plurality of processing units will receive the at least one slice instruction; and
load the at least one slice instruction to the more than one processing unit in response to the global instruction.

16. The computer program product of claim 15, further comprising a computer readable program when executed on a computer causes the computer to process a single input multiple data (SIMD) instruction one clock cycle after processing a multiple instruction multiple data (MIMD) processor instruction.

17. The computer program product of claim 15, further comprising a computer readable program when executed on a computer causes the computer to process a combined SIMD-MIMD processor instruction in a single clock cycle.

18. The computer program product of claim 15, further comprising a computer readable program when executed on a computer causes the computer to retrieve a plurality of slice instructions wherein the plurality of slice instruction are less in number that a quantity of processing units.

19. The computer program product of claim 15, further comprising a computer readable program when executed on a computer causes the computer to process a global instruction, to make the plurality of processing units operate in one of a single instruction multiple data (SIMD) mode, a multiple instruction multiple data (MIMD) mode or a hybrid SIMD/MIMD mode.

20. The computer program product of claim 15, further comprising a computer readable program when executed on a computer causes the computer to forward a specific slice instruction to a specific processing unit.
